(19) United States
(12) Patent Application Publication
(10) Pub. No.: US 2009/0167241 A1
(43) Pub. Date: Jul. 2, 2009

(54) CHARGER DEVICE

(75) Inventors: Yu-Lung Lee, Nanjhuang Township (TW); Ming-Chou Kuo, Taipei City (TW)

Correspondence Address: NIKOLAI & MERSEREAU, P.A., 900 SECOND AVENUE SOUTH, SUITE 820, MINNEAPOLIS, MN, 55402, US

(73) Assignee: Powertech Industrial Co., Ltd., Chung Ho City, (TW)

(21) Appl. No.: 12/233,798

(22) Filed: Sep. 19, 2008

(30) Foreign Application Priority Data
Dec. 28, 2007 (TW) 96150982

(51) Int. Cl. H02J 7/02; H01M 10/46

(52) U.S. Cl. 320/111

(57) ABSTRACT

A charger device includes a body, an AC power input port, a DC power input port, a battery insertion slot and a power output/input port. The body is provided therein with a circuit board. The AC power input port, the DC power input port and the power output/input port are electrically connected to the circuit. The battery insertion slot is provided on the body and electrically connected to the circuit board. Via this arrangement, a charge device can be obtained. Since the AC power input port and the DC power input port are provided simultaneously, the charger device can be used with different power sources and charge an electronic apparatus with the outputted power.

### BACKGROUND OF THE INVENTION

1. Field of the Invention

The present invention relates to a charger device, and in particular to a charger device that provides the necessary power for a mobile apparatus and is usable with different power sources.

2. Description of Related Art

With the tendency toward digitalization, various kinds of electronic devices are very popular, such as mobile phones, notebooks, MP3 players, personal digital, assistants (PDA) or other mobile apparatuses. Due to their advantages of convenience and portability, these electronic devices are widely used in our daily life.

The conventional mobile apparatus has to be charged by means of a charger device that provides the necessary power for the mobile apparatus. A common charger device uses a public power source as an input AC power source. Via a rectifier and charger circuit, the public power can charge the mobile apparatus. Alternatively, the mobile apparatus is externally connected to a public power AC power source. After being voltage-converted, the converted voltage, provides a USB interface with a standard voltage, thereby charging the mobile apparatus.

Taiwan Patent Publication No. M302823 published on Dec. 11, 1996 discloses a multi-function charger including a rectifier, a first step-down transformer, a USB port, a second step-down transformer, electrically-conductive terminals, a control switch, a step-up transformer and a casing. The multi-function charger is a kind of charger device.

However, since this conventional charger device has only one AC power input port, or only one DC power input port, the usage thereof is so limited that it cannot be suitable for different power sources.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a charger device that is usable, with different power sources.

In order to achieve the above objects, the present invention provides a charger device, which includes a body provided therein with a circuit board; an AC power input port electrically connected to the circuit; a DC power input port electrically connected to the circuit board; a battery insertion slot provided on the body and electrically connected to the circuit board; and a power output/input port electrically connected to the circuit board.

The present invention has advantageous features as follows. The present invention is provided with an AC power input port and a DC power input port simultaneously. Thus, a user can choose one of the power input ports according to the practical application, thereby applying to different power sources.

Further, the present invention is provided on the body with a power output switch. After the power output switch is pressed, the power in charger batteries is delivered to the power output/input port to charge a mobile apparatus. Alternatively, the operation can be reversed, that is, the power output/input port can be used to charge the charger batteries.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is a perspective view showing a charger device of the present invention;

FIG. 2 is a top view showing the charger device of the present invention;

FIG. 3 is a left side view showing the charger device of the present invention;

FIG. 4 is a bottom view showing the charger device of the present invention;

FIG. 5 is a right side view showing the charger device of the present invention;

FIG. 6 is a perspective view showing another embodiment of the charger device of the present invention; and

FIG. 7 is a block view showing the circuit of the charger device of the present invention.

### DETAILED DESCRIPTION OF THE PREFERRED EMBODIMENTS

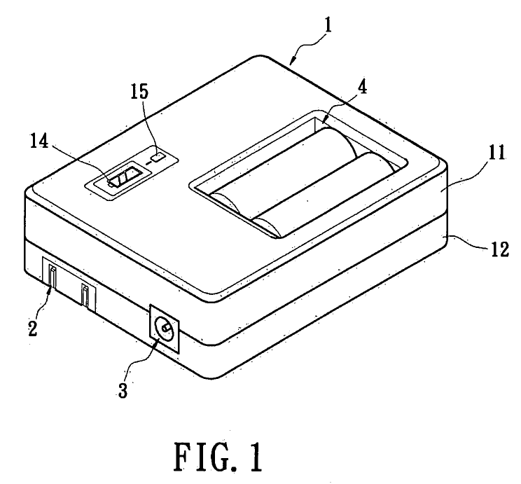

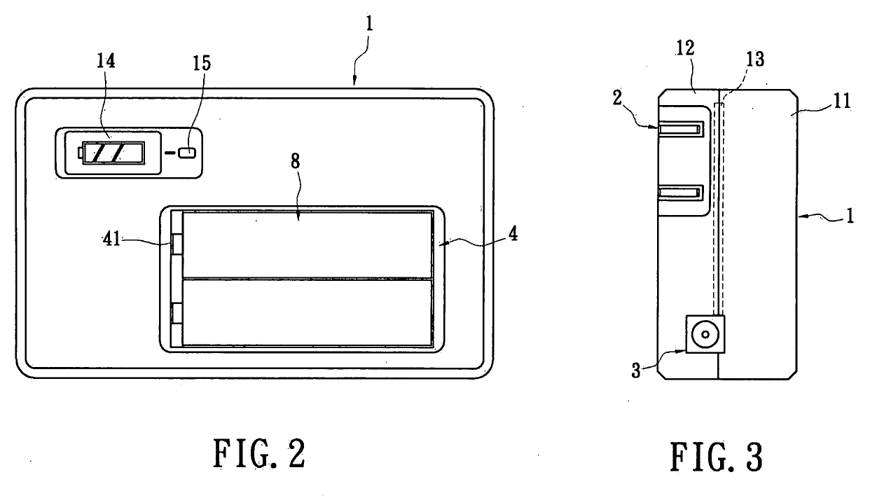

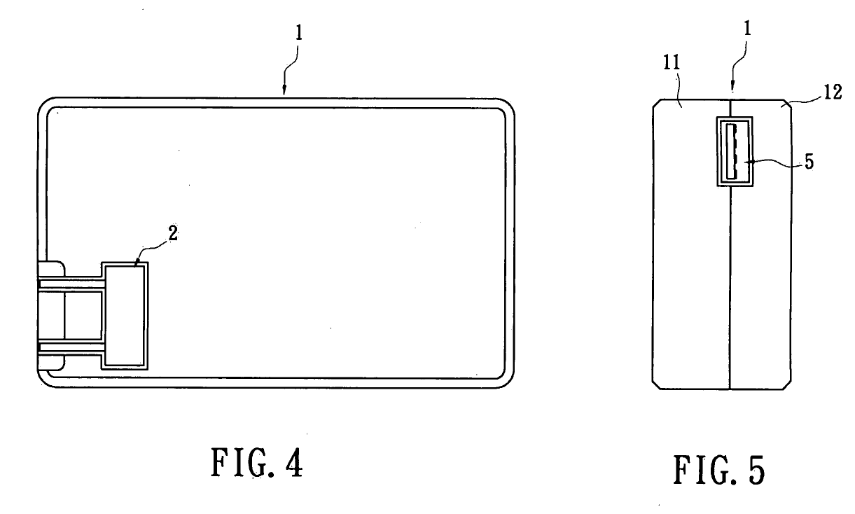

Please refer to FIGS. 1 to 5. The present invention provides a charger device, which includes a body 1, an AC power input port 2, a DC power input port 3, a battery insertion slot 4 and a power output/input port 5. The body 1 comprises a first half casing 11 and a second half casing 12. The first half casing 11 and the second half casing 12 are assembled together to form a hollow casing by means of snapping, screwing or supersonic welding.

The AC power input port 2 is provided on the body 1. The AC power input port 2 is electrically connected to a circuit board 13 within the body 1. The AC power input port 2 is a plug that can be inserted into a public power socket so as to input power to the circuit board 13. The AC power input port 2 can be designed as a push-out plug or a rotary plug, so that the AC power input port 2 can extend from or retract into the body 1 by means of pushing or rotating out. In this way, the AC power output port 2 can retract into the body 1 when not in use, thereby enhancing the aesthetic feeling and protecting the AC power input port 2 from suffering damage due to collision.

The DC power input port 3 is provided on the body 1. The DC power input port 3 is exposed to the outside of the body 1. The DC power input port 3 is electrically connected to the circuit board 13 within the body 1. The DC power input port 3 is a DC socket that can be electrically connected to a suitable DC power source so as to input power to the circuit board 13.

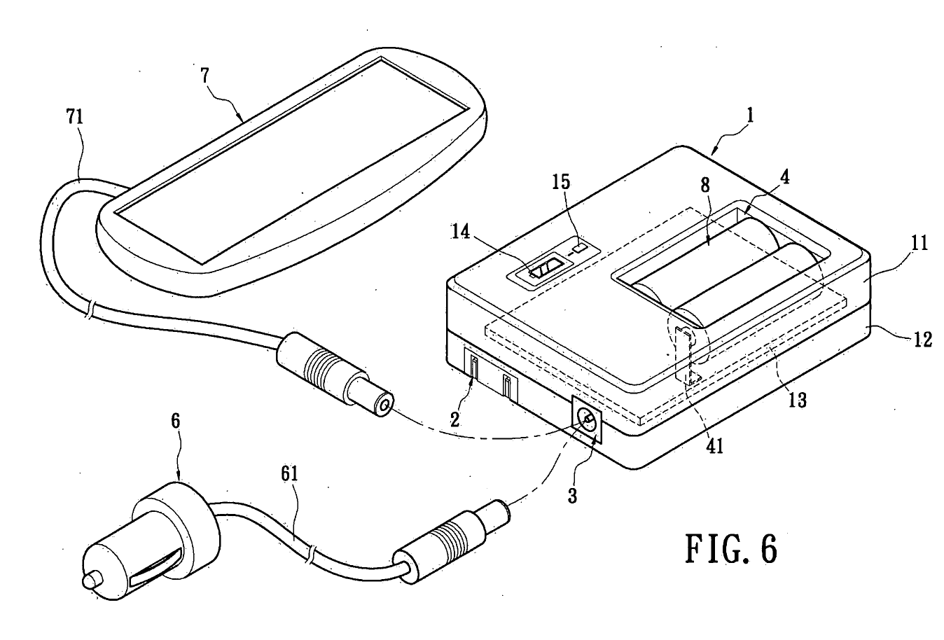

As shown in FIG. 6, in the present embodiment, the DC power input port 3 is electrically connected to a transmission line 6. One end of the transmission line 61 is connected to a plug 6 of an automobile cigarette lighter that is inserted into a socket of the automobile cigarette lighter for inputting automobile power to the circuit board 13. The DC power input port 3 can be electrically connected to a transmission line 71. One end of the transmission line 71 is connected to a solar plate 7 for inputting solar energy to the circuit board 13.

The battery insertion slot 4 is provided on the body 1. The battery insertion slot 4 is recessed in a top surface of the body 1. The interior of the battery insertion slot 4 is provided with a plurality of electrically-conductive pieces 41. The electrically-conductive pieces 41 are electrically connected with the circuit board 13 within the body 1. The battery insertion slot 4 allows a plurality of charger batteries 8 to be disposed therein. The charger batteries 8 are electrically connected with the circuit board 13 via the electrically-conductive pieces 41, thereby charging the charger batteries 8. The charger batteries 8 are used to charge the mobile apparatus outdoors. The body 1 is provided thereon with a display screen 14 for displaying the state of charge. The display screen 14 is electrically connected to the circuit board 13. The display screen 14 is used to display the charging state presently for the user.

The power output/input port 5 is provided on the body 1. The power output/input port 5 is exposed to the outside of the body 1. The power output/input port 5 is electrically connected to the circuit board 13 within the body 1. The power output/input port 5 is a UBS socket that can be inserted by a USB plug. Alternatively, a USB power adapting line is electrically connected to the mobile apparatus, so that the power can be outputted to the mobile apparatus or re-charged to the charger batteries 8.

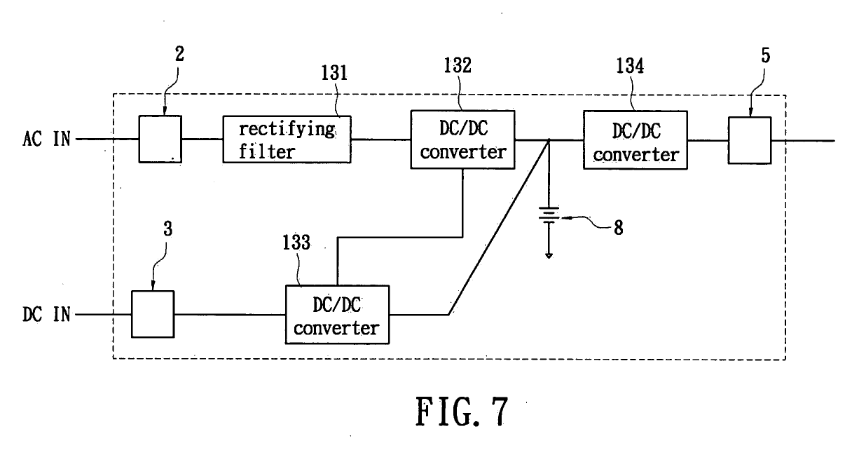

As shown in FIG. 7, the circuit board 13 has a rectifying filter 131. The rectifying filter 131 is electrically connected to the AC power input port 2 for filtering and rectifying the AC into a DC high-voltage circuit. The rectifying filter 131 and the DC power input port 3 are electrically connected to a DC/DC converter 132, 133 respectively, thereby changing the DC to a desired DC lower voltage. The DC/DC converters 132 and 133 are further electrically connected to the charger battery 8, a DC/DC converter 134 and the power output/input port 5.

The body 1 is provided thereon with a power output switch 15. The power output switch 15 is electrically connected to the circuit board 13 within the body 1. The power output switch 15 is switched to select, the charging operation of the charger batteries 8 or the connection between the charger batteries 8 and the power output/input port 5 to charge the mobile apparatus. Alternatively, the operation can be reversed. The power output/input port 5 can input power to charge the charger batteries 8.

The charger device of the present invention is provided with an AC power input port 2 and a DC power input port 3 simultaneously. Thus, a user can choose one of the power input ports 2 and 3 according to the practical application, thereby applying to different power sources.

When the user goes out with the mobile apparatus having no power, if the user cannot find any AC or DC power source, the user can use the fully-charged charger batteries 8 and press the power output switch 15, so that the power stored in the charger batteries 8 can be delivered to the power output/input port 5 to charge the mobile apparatus. At the same time, the display screen 14 will display the remaining amount of power in the charger batteries 8.

If the charger batteries 8 have no power or insufficient power, the user can further buy common batteries to charge the mobile apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A charger device, comprising
a body provided therein with a circuit board;
an AC power input port electrically connected to the circuit;
a DC power input port electrically connected to the circuit board;
a battery insertion slot provided on the body and electrically connected to the circuit board; and
a power output/input port electrically connected to the circuit board.

2. The charger device according to claim 1, wherein the body is provided thereon with a power output switch that is electrically connected to the circuit board.

3. The charger device according to claim 1, wherein the body is provided therein with a display screen for displaying the state of charge.

4. The charger device according to claim 1, wherein the AC power input port is provided on the body.

5. The charger device according to claim 1, wherein the DC power input port is provided on the body.

6. The charger device according to claim 1, wherein the DC power input port is electrically connected to a plug of an automobile cigarette lighter.

7. The charger device according to claim 1, wherein the DC power input port is electrically connected to a solar plate.

8. The charger device according to claim 1, wherein a plurality of charger batteries is disposed in the battery insertion slot, the plurality of charger batteries are electrically connected to the circuit board via electrically-conductive pieces.

9. The charger device according to claim 1, wherein the power output/input port is provided on the body.

10. The charger device according to claim 1, wherein the power output/input port is a USB socket.
